(19) United States
(12) Patent Application Publication
(10) Pub. No.: US 2007/0194872 A1
(43) Pub. Date: Aug. 23, 2007

(54) Electromagnetic actuator

(76) Inventors: Andrew D. Pfister, Rolling Meadows, IL (US); James F. Fargo, Winnetka, IL (US); Todd W. Klippel, Oak Park, IL (US); John C. Opfer, Chicago, IL (US); Joel A. Ramos, Chicago, IL (US); Daniel M. Terhune, Libertyville, IL (US); Christopher R. Lettow, Buffalo Grove, IL (US)

Correspondence Address: James V. Lapacek;S & C Electric Co., 6601 N. Ridge Blvd., Chicago, IL, 60626, US

(21) Appl. No.: 11/599,096

(22) Filed: Nov. 13, 2006

Related U.S. Application Data
(60) Provisional application No. 60/741,518, filed on Dec. 1, 2005.

(51) Int. Cl. H01F 7/08

(52) U.S. Cl. 335/229

(57) ABSTRACT

An electromagnetic actuator is capable of providing a high speed driving force, for example, for driving the contacts of a circuit breaker or similar power distribution equipment. The electromagnetic actuator may use a directly powered moving coil element in combination with one or more energized stationary coils to generate an output force using reduced requirements for current, voltage and current/voltage rate-of-change. Precise control of actuator motion is obtained by permitting different supply voltages, firing times and capacitor supplies. The electromagnetic actuator may further incorporate a return spring arrangement and a magnetic latch arrangement.

This application claims the benefit of U.S. Provisional Application No. 60/741,518 filed Dec. 1, 2005.

### TECHNICAL FIELD

This patent relates to actuators, such as the type of actuators used in controlling high-power circuit breakers, circuit switchers, fault interrupters, disconnectors, grounding devices, and the like, and more particularly, to a high speed electromagnetic actuator.

### BACKGROUND

High speed operation and actuation is necessary or desirable in many types of power distribution equipment. Typical applications include providing fault protection of sensitive loads while ensuring substantially continuous electrical services. Providing continuous electrical service in the presence of a fault often involves quickly transferring the load from a primary source (usually a utility) to a secondary source (a separate source or utility or a local source such as a generator). High speed fault clearing is desirable to minimize voltage disturbances for other loads on the same feeder. This technique is especially prevalent in transmission systems and closed loop distribution systems.

Electromagnetic devices have seen application as actuators for high speed operation of power distribution equipment. Electromagnetic actuators used in circuit breakers and other power distribution equipment may employ one or more solenoids with ferromagnetic stators and armatures expending energy stored or created in the magnetic circuit to perform mechanical work. A small class of electromagnetic actuators uses repulsive forces to drive the load. In this type of actuator, a current with a high rate of change flows through a coil inducing opposing current in an adjacent conductive plate. The opposing currents repel each other driving the plate away from the coil. Achieving the high rate of change requires high voltages; achieving significant forces requires high current. These factors require large capacitive power supplies. In addition, the current in the coil and plate cannot reach their peak value at the same time, reducing the maximum possible force.

### BRIEF DESCRIPTION OF THE DRAWINGS

FIG. 1 is a cross-section view of an electromagnetic actuator;

FIG. 2 is a diagram of a circuit for driving an electromagnetic actuator such as an electromagnetic actuator in accordance with one or more of the herein described embodiments;

FIG. 3 is a diagram of an alternate circuit for driving an electromagnetic actuator such as an electromagnetic actuator in accordance with one or more of the herein described embodiments;

FIG. 4 is a cross-section view of an alternate structure for an electromagnetic actuator;

FIG. 5 is a cross-section view of a further alternate structure for an electromagnetic actuator;

FIG. 6 is a plot of force versus travel for an electromagnetic actuator constructed with a non-magnetic and an electromagnetic actuator constructed using steel parts;

FIG. 7 is a diagram of a circuit for driving an electromagnetic actuator such as an electromagnetic actuator in accordance with one or more of the herein described embodiments;

FIG. 8 is a cross-section view of a further alternate structure for an electromagnetic actuator;

FIG. 9 is a schematic diagram of a power distribution component coupled to an electromagnetic actuator;

FIG. 10 is a diagram of a further circuit for driving an electromagnetic actuator such as an electromagnetic actuator in accordance with one or more of the herein described embodiments.

### DETAILED DESCRIPTION

An electromagnetic actuator is capable of providing a high speed driving force, for example, for driving the contacts of a circuit breaker or similar power distribution equipment. The electromagnetic actuator may use electromagnetic forces for motion and a permanent magnet for latching. A velocity proportional feedback device, or other suitable structure, may provide component speed control. An electromagnetic actuator in accordance with one more of the herein described embodiments may minimize the number of moving parts while providing reliable and consistent performance.

In accordance with one or more of the herein described embodiments, an electromagnetic actuator may use a separate coil supplying an opposing current, while the moving element is directly powered. Directly powering the moving element may reduce the requirements for current, voltage and current and/or voltage rate-of-change permitting use of a smaller power supply. Separate coils may further allow for precise control of actuator motion by permitting different supply voltages, firing times and capacitor supplies. The coils may be identical or of different designs. The coils may be connected in parallel or series and may be powered separately. Lower current and voltages allow for economical construction using circuit elements typically specified for solenoid-type actuators.

The electromagnetic actuator may incorporate a return spring arrangement. One or more permanent magnets may be employed to hold the moving element in place at both ends of its motion. The retaining force may be overpowered by the coil generated repulsive force and/or the latching magnet flux may be reversed by applying a current to an adjacent coil.

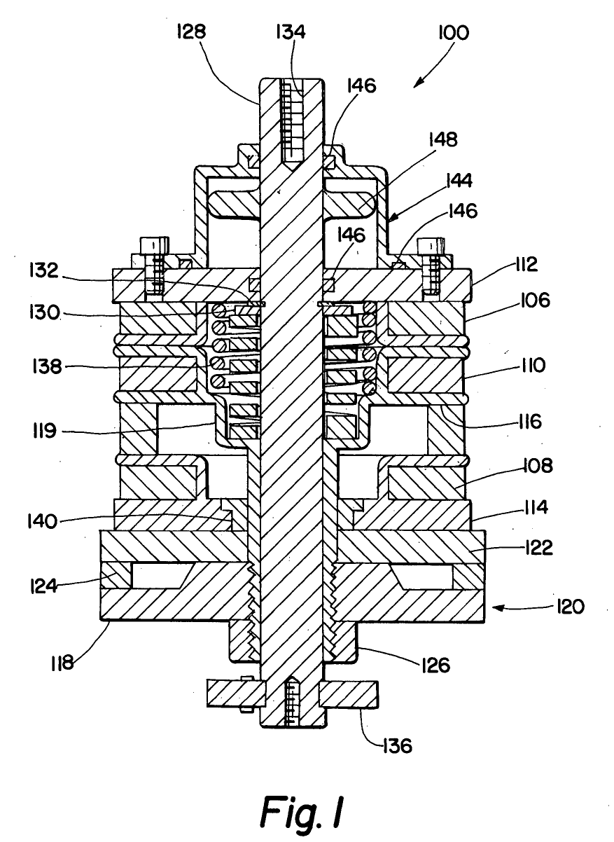

A velocity proportional feedback device, such as a hydraulic damper or dash-pot, may be provided. Alternative type velocity control devices include pneumatic dampers or an additional electromagnetic coil, e.g., a voice-coil. The velocity control device may operate to control the speed of the moving element throughout its stroke. Referring to FIG. 1, an electromagnetic actuator 100 may have four primary groups of components: electromagnetic coils, a permanent magnet latch, springs and a hydraulic damper. The electromagnetic coils convert electrical energy into mechanical energy, for example for operating a piece of power distribution equipment such as circuit breaker contracts. The permanent magnet latch holds the moving element in a first position or a second position, for example, to hold the circuit breaker contacts closed or, once opened, to hold the circuit breaker contacts open. The springs may serve multiple purposes, such as, maintaining a force on the moving element, for example, to maintain a force on the circuit breaker contacts, or to store mechanical energy to assist in moving the moving element, for example, to assist in moving the circuit breaker contacts. The hydraulic damper controls the speed of the moving element.

Referring to FIG. 1, the actuator 100 may include three coils, a stationary first coil 106 or opening coil, a stationary second coil 108 or closing coil and a moving coil 110 or armature or moving element. Each coil 106, 108 and 110 may be wound on a stainless-steel bobbin 112, 114 and 116, respectively. The bobbin 116 may further define an armature 104 as part of the moving element. Stainless steel typically is non-magnetic, has low conductivity and good mechanical properties. The first coil 106 and the second coil 108 may be wound clockwise, while the moving coil 110 may be wound counter-clockwise.

In the actuator first position, the moving coil 110/armature 104 and opening coil 106 are adjacent to one another, as shown. The moving coil 110 is held in place by a plunger 118 of the magnetic latch 120, which rests on a latch stator 122. The permanent magnet 124, which may be ring-shaped, remains in contact with the stator 122. The plunger 118 is threaded to the armature 104 and secured with a locknut 126. The armature 104 pushes on the compliance spring 119, which in turn pushes on the drive shaft 128 through a washer 130 and retaining ring 132. The drive shaft 128 applies pressure to a driven element, such as a circuit breaker contact, through a ferrule 134 that is threaded into the drive shaft 128.

To provide an operating force in a first direction, for example, to provide an opening force on the circuit breaker contact, the moving coil 110 and the first coil 106 may be energized in parallel. The electromagnetic force from the opposing currents (the Lorentz force) drives the two apart. The first coil 106 is fixed, so the moving coil 110 moves from a first position in the first direction toward the second coil 108. After the moving coil 110 has moved a short distance from the first coil 106, it strikes the flange 136 of the drive shaft 128. This impact initiates motion of the drive shaft 128 in the first direction. For example, when used in conjunction with a circuit breaker, the impact provides energy to break any contact welds. After a brief period of bounce, the spring 138 pushes the moving coil 110 and drive shaft 128 to the second position. In the second position, the armature 104 rests against a linear bearing 140 and the shaft flange 136 rests against the bottom of the armature 104. To provide an operating force in a second direction, opposite the first direction, the second coil 108 and the moving coil 110/armature 104 start adjacent each other. Once energized, the opposing currents initiate travel from the second position in the second direction, for example, to drive the contacts of the circuit breaker closed. The armature bobbin 116 quickly travels to the latched position with the plunger 118 held against the face of the stator 122. The drive shaft 128 is retarded by a velocity-feedback device 142, e.g., a hydraulic damper, and is driven more slowly to the closed position by the compressed compliance spring 119.

Movement of the drive shaft 128, and hence movement of a component or components of a coupled device, is controlled by the velocity feedback device 142, which may be a hydraulic damper. The velocity-feedback device 142 produces a force proportional to velocity that opposes the movement of the coupled device. The hydraulic damper may include a housing defining a cup portion 144 and one face of the stationary first coil bobbin 114. The hydraulic damper is filled with an appropriate fluid, such as silicone fluid, and sealed with o-rings 146. Force is generated and transmitted to the coupled device through a flange 148 on the drive shaft 128 that acts like a piston within the cup 144. The relation between the force and velocity may be controlled by the geometry of the flange 148, the cup 144 and the properties of the fluid.

In general, the design is intended to be self-aligning. Alignment to the drive shaft 128 is provided by the o-rings 146 and the bearing 140 in the second coil bobbin 114. Provisions may also be made in the drive shaft 128 for connections to the coupled device as well as to for a travel indicator. Additionally, the actuator 100 may be retained within a frame or housing (not depicted) and may include suitable electrical connections for coupling to a power supply and/or a controller.

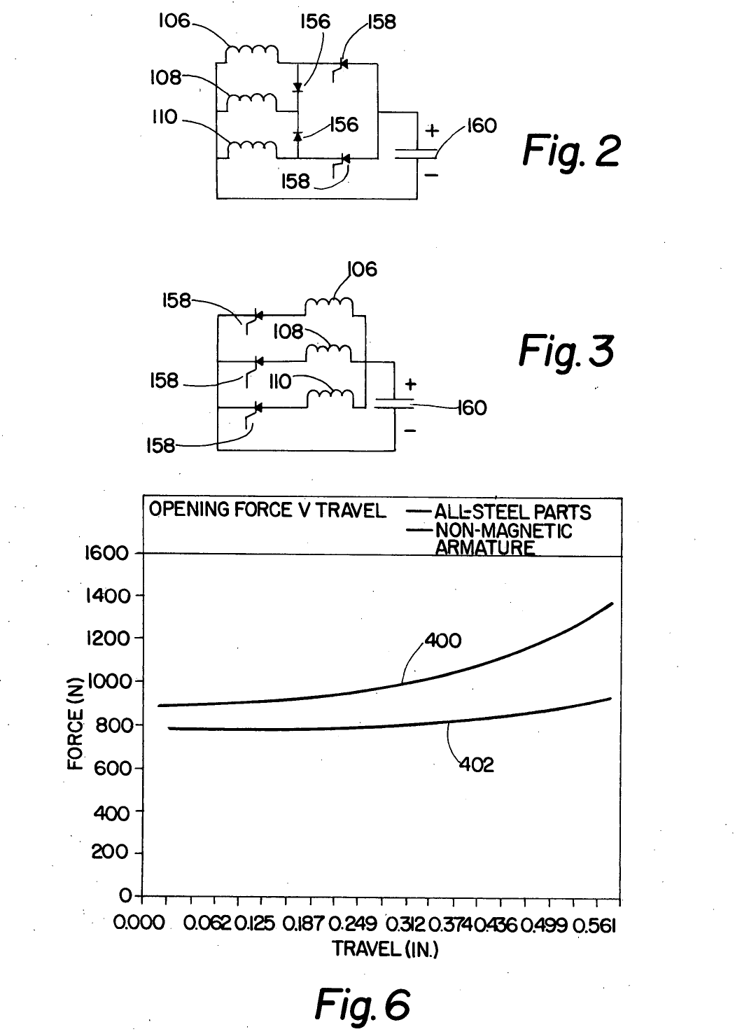

Referring to FIGS. 2 and 3, the electrical circuit can take several forms. In FIG. 2, the coils 106, 108 and 110 are automatically fired together by the arrangement of power diodes 156 and SCR's 158. Triggering an SCR 158 by a suitable controller discharges a power supply 160, such as a capacitor bank, through the desired coils. In FIG. 3, each coil is fired by its own SCR 158, allowing more control over the coil firing sequence.

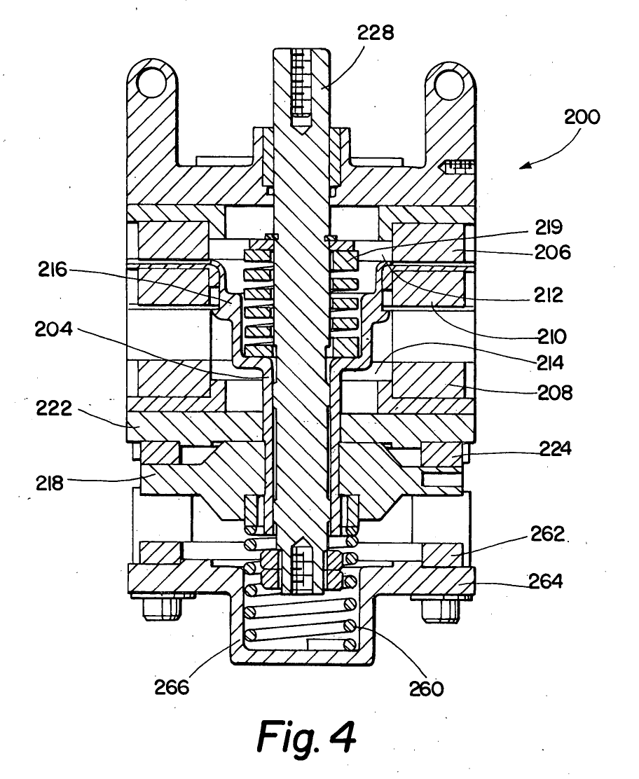

FIG. 4 illustrates an actuator 200. The actuator 200 has a similar construction as the actuator 100, and like references numerals in the 200 range are used to designate like or similar elements. That is, in FIG. 2 the element 202 corresponds to the element 102 of FIG. 1, and so forth. This convention is used throughout this detailed description. Thus, for the actuator 300, elements 102, 202 and 302 are corresponding, and so forth.

As seen in FIG. 2, the arrangement of the springs and magnets is different. For the actuator 100, stored spring energy drives the drive shaft 128 from the first position to the second position and magnetic energy drives the drive shaft 128 from the second position to the first position. For the actuator 200, the spring 138 is replaced by a spring 260 and a second magnet 262 is added to the magnet 224. The actuator 200 is designed to have stored energy, which may be substantially equal, in the first or second positions. That is, the energy stored in the spring 260, while in the second position, may be substantially equal to that stored in the compliance spring 219 in the first position. Similarly, energy stored in the permanent magnets 224 and 262 is substantially the same in both positions. In theory, the actuator 200 may be moved between the first and second positions with a relatively small amount of additional energy, i.e., sufficient energy to overcome frictional losses, further reducing operating energy requirements. The spring 260 and the magnet 262 may allow the use of a smaller electromagnetic pulse to complete the closing stroke and compress the compliance spring 219. Thus, substantially constant velocities may be achieved without the velocity feedback device 142.

Referring to FIG. 4, the plunger 218 mates with either of two magnetic circuits. The first magnetic circuit includes the magnet 224 and the stator 222. The second magnet circuit is added over the actuator 100. The second magnet circuit includes the magnet 262, which may have a substantially similar construction as the magnet 124, and the stator 264.

The spring 260 is compressed between an end of the armature 204 and a pocket 266 in the stator 264 in the second position. The spring rate of the spring 260 and the compliance spring 219 and their corresponding deflections are chosen such that the total energy stored in the springs is the same in either the first or second positions.

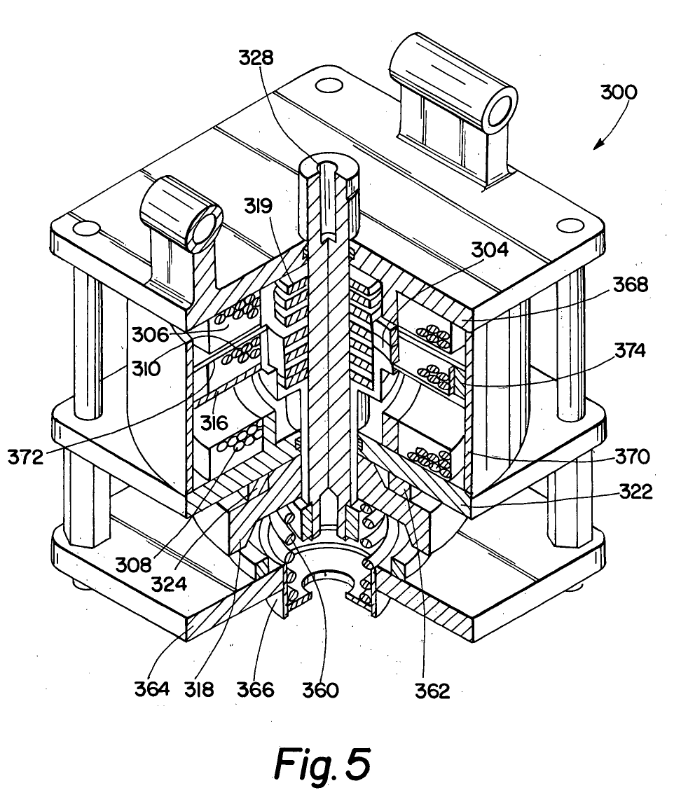

The actuators 100 and 200, as described above, contained no magnetic materials in the vicinity of the coils. The magnetic field generated by each coil was identical to that produced in open air. An alternate actuator 300, depicted in FIG. 5, adds magnetic steel around the coils. This produces two benefits: more total flux is generated, and more of the flux generated crosses the moving coil. The cross-product of current and flux produces the axial Lorentz force which drives the actuator. Because the magnetic circuit is not completely closed, there is minimal increase in the circuit inductance.

The actuators 100 or 200 typically fired two coils at once: either the first or the second coil 106 and 108 and the moving coil 110. These coils were adjacent at the beginning of the stroke, and repelled each other. The unfired coil, either coil 106 or 108 may be fired near the end of the stroke to attract the moving coil 110, as will be described below. This coil, however, could not add significant flux across the moving coil until it approached. By adding steel parts to channel the flux, more flux from the far coil can pass across the moving coil early in the stroke. Also, if the stationary coils have the same current, and the stroke is short (≦2.5 cm, 1 inch), the total radial component of flux across the moving coil will be nearly constant for the whole stroke; as flux from one coil drops off, the other picks up.

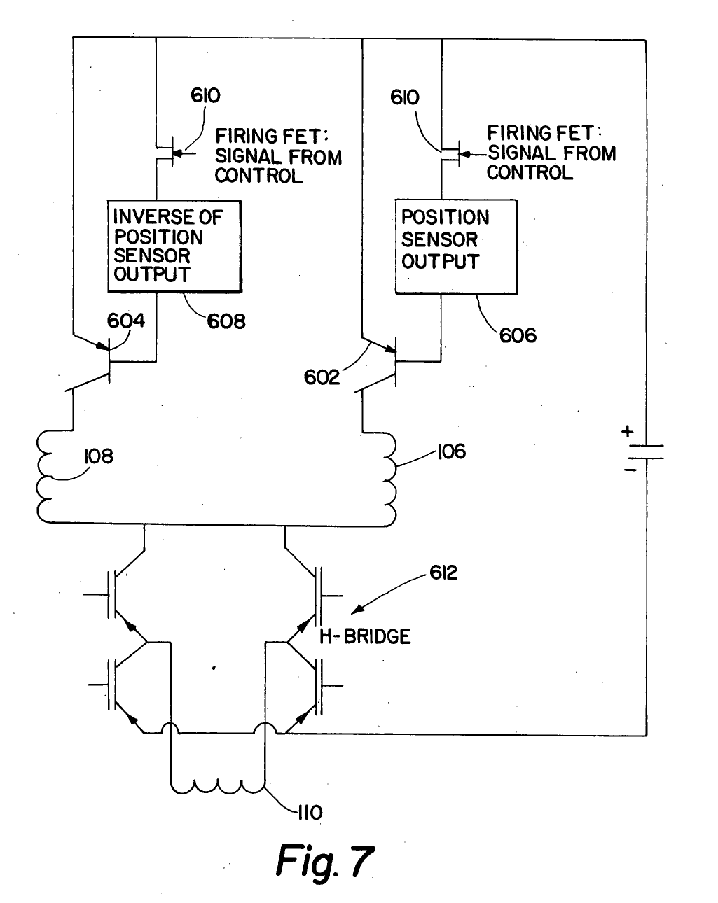

The design of the actuator can be tailored for different purposes. The chart of FIG. 6 shows the force generated along the stroke for two actuator designs. In one design, illustrated by curve 400, all the parts around the coils are magnetic; this produces the maximum force, but is highly non-linear. In the second design, illustrated by the curve 402, the parts that hold the moving coil are non-magnetic. This produces slightly less force, but the output is more constant over the stroke. A section view of high speed electromagnetic actuator 300 incorporating magnetic materials is shown in FIG. 5. Similar to the actuator described above, the actuator 300 uses three coils 306, 308 and 310 to drive to drive an output shaft 328. The actuator 300 is held in the first position (shown) by a first magnetic circuit. This circuit includes a permanent magnet 324, a stator 322, and a plunger 318. A first magnetic circuit is also shown to hold the actuator 300 in a second position (not depicted). This circuit may include a permanent magnet 362, stator 364, and the plunger 318. A spring 360 is shown compressed between the bottom of the plunger 318 and a pocket 366 in the stator 364 of the magnetic circuit.

The coil stators 322 and 368 and output shaft 328 are made of mild steel. An outer mild-steel tube 370 has also been added to channel flux from the stationary coils 306 and 308. This constitutes the constant force, curve 402, form of the actuator 300. More force can be generated by making the armature 304 and flanges 372 from mild steel and adding a mild-steel collar 374 to the moving coil 310. This configuration produces the non-linear force curve, curve 400.

As noted above in connection with FIGS. 2 and 3, SCRs may be used to control the firing of the coils for affecting operation of the actuator. The SCRs operate responsive to signals received from a suitable controller and an associated position sensor. FIG. 7 illustrates a circuit 600 that uses proportional current controlled directly by an output of a discrete position sensor.

The circuit 600 is described with reference to the actuator 100, but it should be understood that the circuit 600 may be used in conjunction with an actuator in accordance with any one or more of the herein described embodiments of actuators or modifications thereof. Bipolar transistors 602 and 604 couple to the first coil 106 and the second coil 108. The transistors 602 and 604 permit a current flow in the main channel that is proportional to the current in the gate. For discrete control, the transistor gate current may be derived directly from the position transducer 606 and the inverse thereof 608. To ensure complete cutoff of the coil current, each transistor gate may further be controlled by a field effect transistor (FET) 610. The FETs 610 are normally open, closing in response to an OPEN or CLOSE signal from a suitable controller, allowing gate current to flow. A bi-directional IGBT bridge 612 couples to drive the moving coil 110.

As shown in FIG. 7, the circuit 600 and the coils 106, 108 and 110 are arranged to provide an attractive pulse at the end of the stroke. The coils 106 and 108 are electrically in parallel and wound in opposite directions. The moving 110 current is thus always the sum of the current in the other two coils. The position transducer 606 output is fed directly to the transistor gates for operating the actuator from the first position to the second position. The inverse position transducer output 608 provides for operating the actuator from the second position to the first position.

If the position transducer 606 output is linear with position, the signal will be linear growing in value as the plunger 118 comes to rest at the second position. The second coil 108 current will begin at a maximum, repelling the moving coil 110, because their currents are opposite. As the moving coil 110 travels to the second coil 108 current will be reduced and the first coil 106 current will increase, attracting the armature 110, because the currents are in the same direction. Inductance of the coils prevents the currents from exactly mimicking the position signal.

The linear transducer may be inefficient because the effects of the stationary coils 106 and 108 are equal at the midpoint of travel. This can be remedied by using a non-linear position transducer. One option is to have a Hall-Effect sensor embedded in the face of the permanent magnet stator 122. As the air gap is reduced, the magnet flux will increase in response to the reduced reluctance. This effect is non-linear. The result is the second coil 108 repelling the moving coil 110 for a much greater percentage of the stroke. The first coil 106 does not begin to attack until the end of the stroke, when its contribution is most effective.

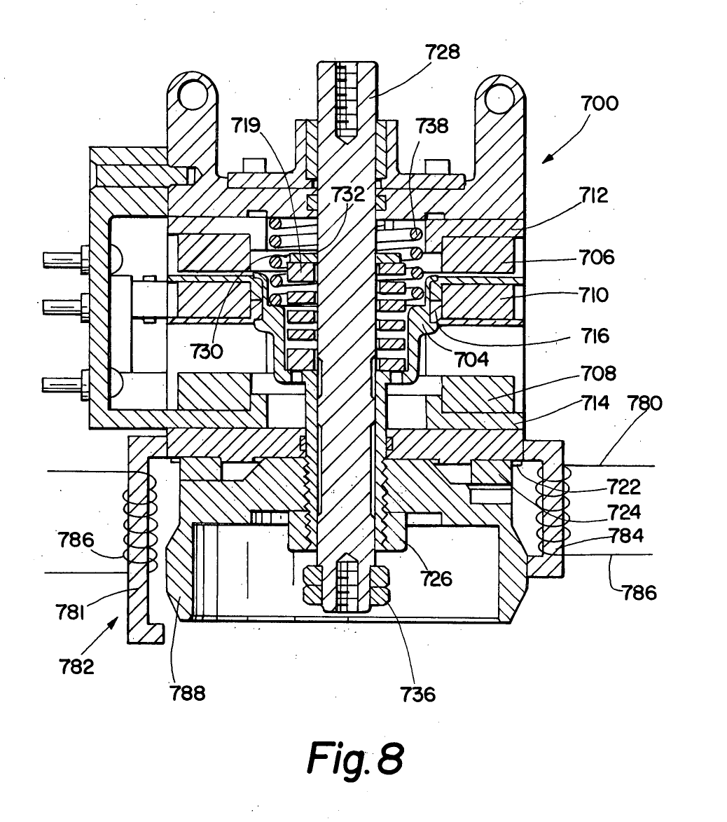

The system could be still more efficient if current dropped off entirely during the middle of the stroke. FIG. 8 illustrates an actuator 700 that includes inductive proximity sensors 780 and 782 for the first and second positions, respectively. The inductive proximity sensors 780 and 782 each may consist of a magnetic circuit 784 and a coil 786. As the object (usually magnetic) in question approaches, the reluctance of the sensor's magnetic circuit 786 changes. The sensors 780 and 782 can be passive or active. In passive operation, a permanent magnet is included in the circuit 784 and the change in flux induces a voltage in the coil 786. In active operation, an alternating current is sourced through the coil 786. The change in magnetic reluctance changes the electrical inductance, producing a change in current and/or a change in the voltage drop across the coil 786, depending on the nature of the source (voltage or current source).

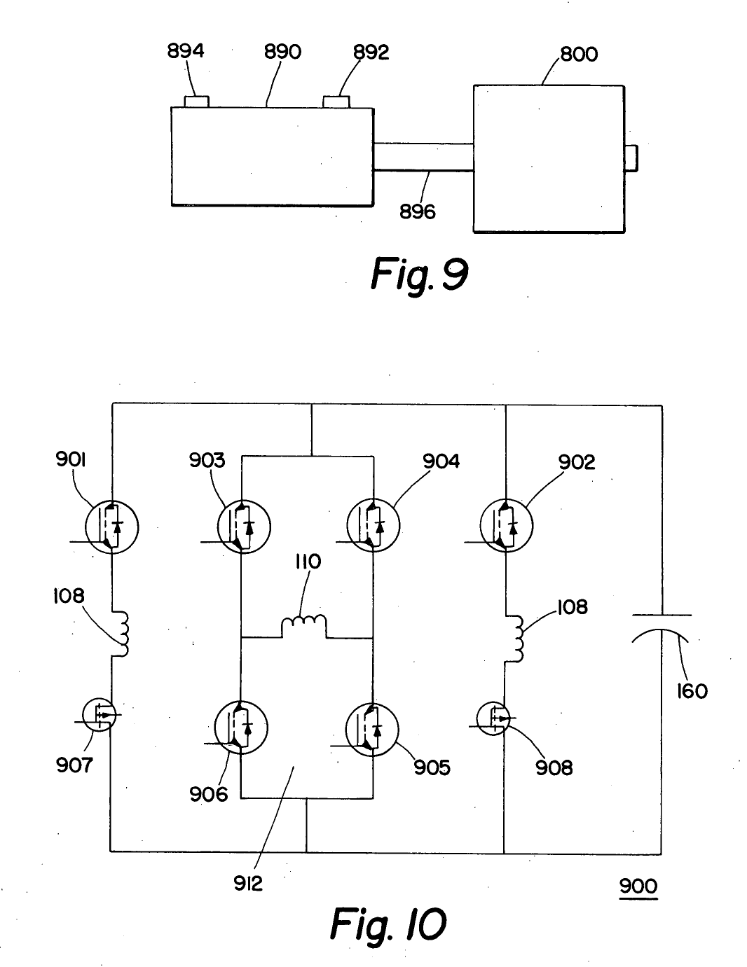

Referring to FIG. 9 a component 890 of a power distribution system, such as a high-power circuit breakers, circuit switchers, fault interrupters, disconnectors, grounding devices, and the like, is coupled to an actuator 800. The component 890 typically includes a moving contact and a stationary contact (not depicted) coupled to terminals 892 and 894, respectively. The moving contact is moveable relative to the stationary contract to open a circuit being bridged by the component 890. The actuator 800 couples to the component via a suitable link 896 to impart an actuating force to the moving contract to move the moving contact from a closed position, wherein the circuit is closed, to an open state wherein the circuit is open and current flow is interrupted. The actuator 800 may be in accordance with any of the herein described embodiments or various modifications thereof.

With additional reference now to FIG. 10, a circuit 900 provides additional control of the current in the driving coils 106, 108, and 110, and thus the motion of the output shaft 328. The use IGBTs for the circuit 900 permits the use of Pulse-Width Modulation (PWM) of the individual driving currents. PWM allows for maximized efficiency and more precise control of position and velocity of the moving coil 110. These in turn allow the actuator to be used for advanced switching functions on the electrical distribution system. These functions include, but are not limited to: making contacts at precise angles of the system voltage, to minimize inrush current and asymmetry; parting contacts at precise voltage angles, to enhance current interruption; and performing rapid pulse-closing operations, to test the condition of the distribution circuit.

The current in each of the stationary closing coil 108 and opening coil 106 is controlled by single IGBTs 901 and 902. Additional MOSFETs 907 and 908 are added on the low voltage side of these coils to facilitate the use of commercially available driver ICs (not depicted). Current in the moving coil 110 is controlled using an H-bridge 912 composed of four IGBTs 903, 904, 905, and 906. Use of the H-bridge 912 allows the direction of the current in the moving coil 110, and thus the motion of the output, to be controlled independently of the direction of its windings.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

We claim:

1. An electromagnetic actuator comprising:
a first stationary coil having a coil winding with a first winding direction;
a second stationary coil spaced apart from the first stationary coil, the second stationary coil having a coil winding with the first winding direction;
a moving coil disposed between the first stationary coil and the second stationary coil and axially moveable relative the first stationary coil and the second stationary coil from a first position wherein the moving coil is adjacent the first stationary coil to a second position wherein the moving coil is adjacent the second coil, the moving coil having a coil winding with a second winding direction opposite the first winding direction;
a drive shaft coupled to the moving coil for movement therewith;
a spring that biases the moving coil toward either the first position or the second position and a permanent magnet latch that latches the moving coil in either the first position or the second position; and
a circuit for selectively energizing the first coil and the moving coil to drive the moving coil from the first position to the second position and energizing the second coil and the moving coil to drive the moving coil from the second position to the first position.

2. The electromagnetic actuator of claim 1, further comprising a velocity control device.

3. The electromagnetic actuator of claim 2, the velocity control device comprising one of the group of devices consisting of a hydraulic damper, a pneumatic damper and an electromagnetic coil.

4. The electromagnetic actuator of claim 1, wherein the spring comprises a first spring and a second spring, the first spring biasing the moving coil toward the first position and the second spring biasing the moving coil toward the second position, the magnetic latch being configured to engage and latch the moving coil in each of the first position and the second position.

5. The electromagnetic actuator of claim 1 comprising a first stationary coil bobbin, a first stationary coil stator, a second stationary coil bobbin, a second stationary coil stator, a moving coil bobbin or a moving coil armature wherein at least one of the first stationary coil bobbin, the first stationary coil stator, the second stationary coil bobbin, the second stationary coil stator, the moving coil bobbin or the moving coil armature includes magnetic material.

6. The electromagnetic actuator of claim 5, wherein the first stationary coil bobbin, the first stationary coil stator, the second stationary coil bobbin and the second stationary coil stator include magnetic material.

7. The electromagnetic actuator of claim 5, comprising a magnetic collar disposed about the first coil, the second coil and the moving coil.

8. The electromagnetic actuator of claim 1, wherein the circuit comprises at least one silicon controlled rectifier (SCR) coupled between a power source and the first stationary coil, the second stationary coil and the moving coil for selectively energizing the first stationary coil, the second stationary coil and the moving coil.

9. The electromagnetic actuator of claim 1, the circuit operable for selectively energizing the first stationary coil, the second stationary coil and the moving coil for providing a repulsive force between one of the first stationary coil and the second stationary coil and the moving coil and an attractive force between the other of the first stationary coil and the second stationary coil and the moving coil.

10. The electromagnetic actuator of claim 1, wherein the circuit comprises a position sensor, the position sensor providing an output indicative of a position of the moving coil between the first stationary coil and the second stationary coil and the circuit being responsive to the output of the position sensor for selectively energizing the first stationary coil, the second stationary coil and the moving coil for providing a repulsive force between one of the first stationary coil and the second stationary coil and the moving coil and an attractive force between the other of the first stationary coil and the second stationary coil.

11. An electromagnetic actuator comprising:
a moving coil disposed between and axial movable relative to a first stationary coil and a second stationary coil between a first position and a second position, wherein with the moving coil in the first position the first stationary coil and the moving coil generate a relative repulsive force therebetween upon energization to move the moving coil from the first position to the second position and with the moving coil in the second position the second stationary coil and the moving coil generate a relative repulsive force upon energization to move the moving coil from the second position to the first position, and
a shaft coupled to the moving coil and moveable therewith to provide a force output form the electromagnetic actuator.

12. The electromagnetic actuator of claim 11 comprising:
a spring that biases the moving coil toward either the first position or the second position and a magnetic latch that latches the moving coil in either the first position or the second position.

13. The electromagnetic actuator of claim 11 comprising
a circuit for selectively energizing the first coil and the moving coil to drive the moving coil from the first position to the second position and energizing the second coil and the moving coil to drive the moving coil from the second position to the first position.

14. The electromagnetic actuator of claim 11 comprising a first stationary coil bobbin, a first stationary coil stator, a second stationary coil bobbin, a second stationary coil stator, a moving coil bobbin or a moving coil armature wherein at least one of the first stationary coil bobbin, the first stationary coil stator, the second stationary coil bobbin, the second stationary coil stator, the moving coil bobbin or the moving coil armature is magnetic.

15. The electromagnetic actuator of claim 11, comprising a magnetic collar disposed about the first coil, the second coil and the moving coil.

16. The electromagnetic actuator of claim 11, wherein the circuit comprises at least one silicon controlled rectifier (SCR) coupled between a power source and the first stationary coil, the second stationary coil and the moving coil for selectively energizing the first stationary coil, the second stationary coil and the moving coil.

17. The electromagnetic actuator of claim 11, the circuit operable for selectively energizing the first stationary coil, the second stationary coil and the moving coil for providing a repulsive force between one of the first stationary coil and the second stationary coil and the moving coil and an attractive force between the other of the first stationary coil and the second stationary coil and the moving coil.

18. The electromagnetic actuator of claim 11, wherein the circuit comprises a position sensor, the position sensor providing an output indicative of a position of the moving coil between the first stationary coil and the second stationary coil and the circuit being responsive to the output of the position sensor for selectively energizing the first stationary coil, the second stationary coil and the moving coil for providing a repulsive force between one of the first stationary coil and the second stationary coil and the moving coil and an attractive force between the other of the first stationary coil and the second stationary coil.

19. The electromagnetic actuator of claim 11, comprising a first spring and a second spring, the first spring biasing the moving coil toward the first position and the second spring biasing the moving coil toward the second position, and a magnetic latch, the magnetic latch being configured to engage and latch the moving coil in each of the first position and the second position.

20. The electromagnetic actuator of claim 11, comprising a velocity control device selected from the group of devices consisting of a hydraulic damper, a pneumatic damper and an electromagnetic coil.
